(19) United States
(12) Patent Application Publication
(10) Pub. No.: US 2004/0019555 A1
(43) Pub. Date: Jan. 29, 2004

(54) Method of guaranteed return on a short-term investment

(76) Inventor: Adonay Lara, Chicago, IL (US)

Correspondence Address: Clifford Kraft, 320 Robin Hill Dr., Naperville, IL, 60540, US

(21) Appl. No.: 10/208,515

(22) Filed: Jul. 29, 2002

(51) Int. Cl. G06F 17/60

(52) U.S. Cl. 705/37

(57) ABSTRACT

A method where a market maker who can purchase instruments at or near the market price and options at or near the bid price and can sell options at or near the ask price can capitalize on spreads while hedging risks. The method leads to a guaranteed profit based on the spread between bid price and ask price and market price and strike price.

### BACKGROUND

1. Field of the Invention

The present invention is generally related to short-term investing and more particularly to hedging risk to achieve a guaranteed return by buying and selling certain securities instruments such as options to achieve a position.

2. Description of the Prior Art

Instruments include, but are not limited to, securities (stock or bond), rights, warrants, commodities, derivative products, option contracts, futures contracts and any other type of investment. Instruments are generally bought and sold on major markets. Option contracts are one type of instrument commonly bought and sold. Options in some ways resemble insurance on an underlying instrument.

Options are contracts that trade on major markets. Generally an option is a contract between a holder (buyer) and a seller (writer) concerning an underlying instrument. When an option is bought, a premium is paid, and when an option is sold, a premium is received. The holder of an option can exercise it under certain conditions to protect the price of an underlying instrument. A wholesaler (member of an exchange) can buy an option at the bid price and sell an option at an ask price. Such a wholesaler will be called a market maker. There is generally a difference or spread between bid and ask prices for various options.

There are two types of options: a call and a put. A call is an agreement whereby the holder of the call (who purchased it for the premium) has the right for a limited period of time to purchase a certain number of shares of a stock or other instrument at a predetermined, fixed price called the strike price. The holder of a put (who purchased it for a premium) has the right for a limited period of time to sell a certain number of shares of a stock or other instrument at a predetermined, fixed price also called the strike price. Options expire in fixed periods of time which we will call a term. For a given stock or other instrument, with the same term, the strike price is the same for a put or call. However, the premiums paid for puts and calls are different. The strike price is usually a little different from the market price.

As previously stated, options are offered for fixed time periods. There are American Style options and European Style options. An American Style option can be exercised anytime during that period by the holder. A European Style option can only be exercised at the end of the term. The holder of an option has the right to exercise or not exercise the option. For example, the holder of a call can exercise the call if the market goes above the strike price because he can buy the stock at the strike price upon exercise and sell it at the higher market value. If the market declines, the holder of a call will not exercise it. The opposite is true of a put. The holder of a put can exercise the put if the market declines and not exercise it if the market goes up. American Style options are exercised automatically at the end of the period if they are “in the money”, while European Style options are no automatically exercised. “In the money” means that the option still has some value. A call would be “in the money” if the market price was higher than the strike price.

Options' periods or terms are short and are generally one month, two months or other term determined by a certain formula used by the markets. Certain types of options called LEAPS may have terms of several years. It is usually possible to buy one month or other short term options. On any day, published tables give the strike price and premiums for one month and other options. There will be four premiums in any row for a one month options. For a call, there will be a bid and ask price (premium), and for a put there will be a bid and ask price.

For every option, there is an underlying instrument such as a stock. A position in the underlying equity can be long or short. A long position means that the person owns the instrument. If the market rises, the person profits; if the market declines, the person loses money (assuming the instrument is sold). A short position means that the person does not own the underlying instrument, but rather has borrowed it from someone else. For example, a stock can be sold short at the current market price. This means that the person receives the value for the sale without owning the stock. However, within a certain time period the person must close out his position by buying the stock at the then current market value. If the market declines between the time of the short sale and the end of the period, the person profits because he buys the stock at a lower price (to pay it back) then he receive at the time of the short sale. If the market rises however, the person will lose money.

Short-term will be defined as being any investment less than around 5 years. While this usually can mean months, it should not be construed to always mean only months, but rather, as stated, can mean several months to several years.

A market maker will be defined as a wholesaler who can buy an option at or very near the bid price and sell an option at or very near the ask price, and can buy an underlying instrument such as an equity at or very near the market price. Generally, the individual investor cannot be a market maker because he generally must pay additional broker fees and other fees for the transaction and cannot buy at or near the market price or bid price and cannot sell at or near the market price or ask price. Usually, the individual investor buys at the ask price and sells at the bid price. Generally a market maker will be a member of a self-regulated organization.

Prior art investment strategies are risky. Buying long risks losing money if the market declines. Selling short risks losing money if the market rises. Buying a call risks losing the premium if the market declines or stays flat. This is the entire investment. Buying a put risks losing the premium if the market rises or stays flat.

The problem with prior art option investing is that the investor, even if a market maker, must not only speculate about what the price of a stock will do, but in the case of an option must also speculate about how soon that will happen (because of the limited life of an option). For example, buying a call will result in a profit only if the market goes up sufficiently during the life of the call; buying a put will result in a profit only if the market goes down sufficiently during the life of the put. Selling a call will only result in a profit if the market goes down during the life of the call; selling a put will only profit if the market goes up during the life of the put.

There are prior art investing methods that involve multiple transactions such as buying an equity long, and buying a put to protect in the case of a market decline, etc. There are even more complex prior art methods that involve buying or selling instruments and buying and selling options. The problem with all these methods is that 1) there is always risk, and 2) there is never a guaranteed gain.

What is needed is a method whereby a market maker can invest without risk and produce a guaranteed profit or gain for a short investment period. Such a method would allow the market maker to compute the guaranteed profit before making the investment. Such a method would make the guaranteed profit in the worst case and more profit in better cases with no risk of loss.

### SUMMARY OF THE INVENTION

The present invention concerns a method for making a guaranteed profit on a one month or other investment. The method allows the market maker to compute the guaranteed profit before investing and hence allows for a decision whether to enter into that particular short-term investment or not based on that guaranteed profit. The method allows the possibility of making more than the guaranteed profit under some conditions. The method can be exercised by a market maker and has no risk.

As will be later explained, the method of the present invention is generally applicable to any instrument that can be bought or sold and that can be protected by a derivative instrument that is bought and sold with a spread that the market maker can capitalize on to achieve a guaranteed gain.

As defined above, a market maker is one who can buy an option at the bid price (or very near the bid price), can sell an option at the ask price (or very near the ask price), and can buy the underlying equity at or near the market price. The method of the present invention comprises a set of steps where a market maker can take either a long or short position on a given set of options (call and put) for a given instrument. A long position can be established by buying the underlying instrument, selling a call, and buying a put. A short position can be established by selling the underlying instrument short, buying a call and selling a put. It will be explained how these steps lead to a guaranteed profit or gain with no risk. It must be remembered that the scope of the present invention is broader than simply stocks and stock options. The underlying instrument can be anything that can be bought or sold long or short and can be protected by some market device such as an option. The method of the present invention will work with any instrument and in particular with anything that can be converted to something of value such as an equity, right, warrant, bond or a commodity. The key to a guaranteed profit is capitalizing on a spread in premiums paid for buying and selling protection.

### DESCRIPTION OF THE DRAWINGS

FIG. 1 is a simplified table showing options available on a stock on a certain day

FIG. 2 shows an embodiment of a long position.

FIG. 3 shows an embodiment of a short position.

### DETAILED DESCRIPTION OF THE INVENTION

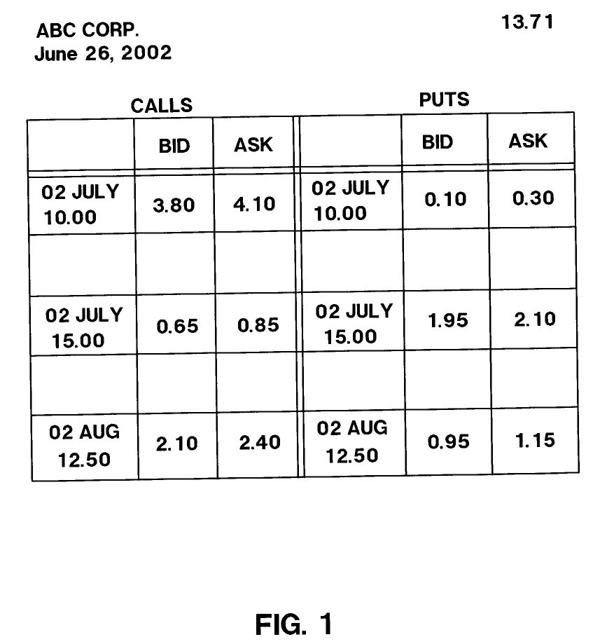

The present invention is a method of short-term investment with a preferred period of one month (any other term will also work). Short-term means any term less than around 5 years, although in many cases the present invention will be used with over periods of one or several months. The market maker performs a simple computation on the numbers representing a pair of options on a particular equity. The pair of options may have the same or a different strike price and may have the same or different terms. FIG. 1 is a table showing options available on ABC Corp. stock on a certain date. The numbers in FIG. 1 will be used as an example for computations and steps to be explained. It should be remembered that these numbers are simply used as examples of the functioning of the invention and that the present invention is not limited simply to stocks or stock options. In FIG. 1, the 3rd row shows a set of options on ABC stock with a strike price of $15.00 (in the box on the left hand column). The important numbers on that row are the bid and ask prices for a call (0.65 and 0.85 respectively), and the bid and ask prices for a put (1.95 and 2.10 respectively). The market price is shown at the top right hand side of the table as $13.71.

As previously stated, it is possible to take either a long position or a short position with the method of the present invention. It will be later described how to analyze a row such as the 3rd row of FIG. 1 to determine whether it is better to take a long or short position (or not to invest in that row). It should be remembered that using stocks and stock options is only one embodiment of the present invention. Any type of instrument can be used and is within the scope of the present invention.

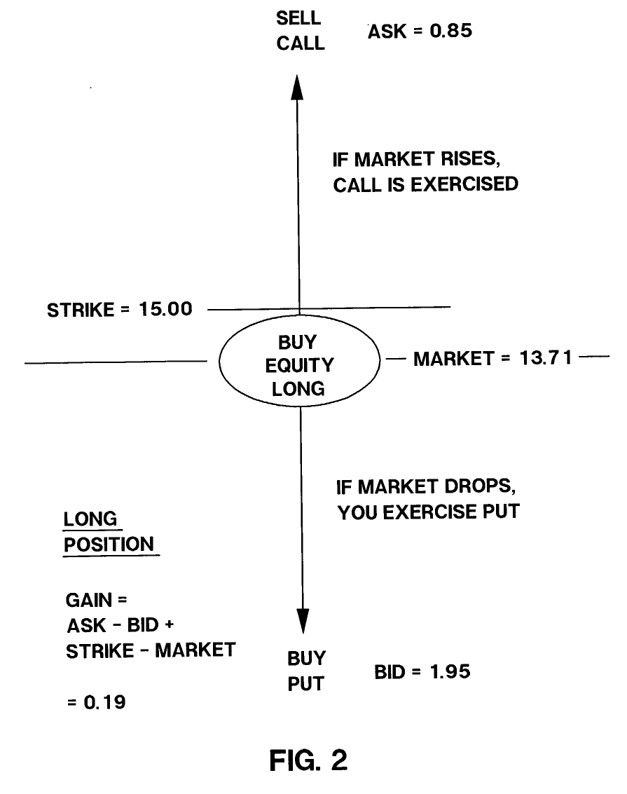

Turning to FIG. 2, we will now describe how to take a long position using row 3 of FIG. 1. A long position is taken by making a alliance or an agreement simultaneously with a seller of an instrument and a buyer of a call option contract and a seller of a put option contract, for example by first buying the underlying equity (in this case a certain number of ABC shares—say 100 shares). These shares will be purchased at the market price which appears above the table in FIG. 1 as $13.71 (per share). Next a call is sold. For selling the call (using row 3), the market maker receives the ask premium of $0.85 (per share). Next a put is bought. For buying a put, the market maker pays $1.95. At the end of 1 month, if the market has sufficiently risen, the call will be exercised and the market maker must sell the stock that he holds long for the strike price of $15.00. At the end of 1 month, if the market has declined, the market maker will exercise the put and sell the stock being held at the strike price of $15.00. In either case the market maker has received $15.00 for the stock, paid $13.71 for the stock, received 0.85 for the call sold, and paid $1.95 for the put bought. When these four quantities are added as signed numbers, the result is $0.19 positive. This is the guaranteed profit or gain. This is 1.21% guaranteed return over the term of the options. Multiplying by 12, this can be projected to a return of 16.63% (per year). If one used margins (borrowed money), the projected yield could be as high as 25% (this depends on interest rates). All of this was accomplished with no risk since the numbers are identical whether the market rises, declines or remains the same.

However, there are better possible scenarios that could (but are not guaranteed) happen. For example, the market could go up early in the cycle possibly causing the owner of the call to exercise it early (the holder of an option is free to exercise it anytime during its life or term). Of course, if that happens, the market maker must sell the stock at the strike price of $15. In that case, the stock is gone, but the market maker still holds the put. If the market then declines below the strike price, the market maker can exercise the put and sell the number of shares at the strike price of $15 (while buying them at the new lower market price). Thus can result in an absolute maximum gain of the strike price (such a large gain would mean the stock went to zero) While the maximum gain is unlikely, some gain above the guaranteed amount is possible with luck.

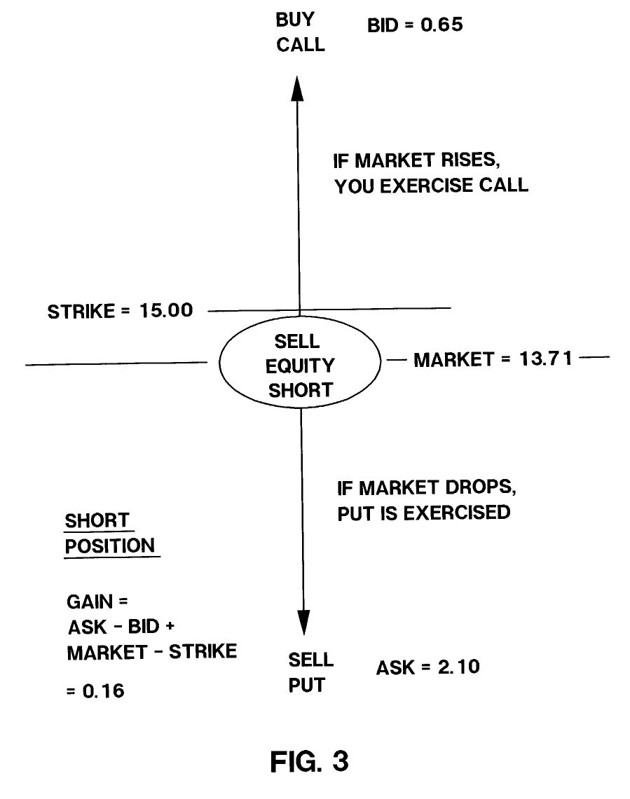

Turning to FIG. 3, we will now describe how to take a short position using row 3 of FIG. 1. A short position is taken making an agreement simultaneously with a buyer of an instrument, the seller of a call option and the buyer of a put option, for example by first selling the underlying equity (in this case a certain number of ABC shares—say 100 shares) short. These shares will be sold at the market price which appears above the table in FIG. 1 as $13.71 (per share) and the market maker receive the value of the sale. Next a put is sold. For selling the put, the market maker receives the ask premium of $2.10 (per share). Next a call is bought. The market maker pays the bid price of 0.65. At the end of the period, the market maker will have to buy the stock he sold short. If the market has risen, the market maker will exercise the call and buy the stock at the strike price of $15.00. If the market goes down, the holder of the put will force the market maker to buy the stock at the strike price of $15.00. In any case, the market maker makes a guaranteed minimum profit or gain of 0.16 per share. This is approximately 2.13%. This can be projected to around 14% per year and with margin to much higher depending on interest rates. This was also with no risk because it did not matter whether the market rose or declined.

However, there are also better possible scenarios with the short position. For example, if the market first drops, the holder of the put may exercise it early. In this case, the market maker must buy the number of shares from the holder of the put at the strike price of $15 (and use them to pay back the short sale). However, the market maker still holds the call. If the market then goes up above the strike price, the market maker can exercise the call and buy the number of shares at the strike price and then turn around and sell them at the now higher market price. In this case, there is no theoretical limit on the gain. It depends on how high the stock is at the end of the period (or whenever the call is exercised).

It can be appreciated that the scenarios described above both lead to a guaranteed return with no risk for a market maker. Formulas can describe the two cases: The guaranteed profit is: Long Gain=Ask(call) Price−Bid(put) Price+Strike Price−Market Price; Short Gain=Ask(put) Price−Bid(call) Price−Strike Price+Market Price. This guaranteed minimum can be computed before the trading starts. The market maker can thus make this computation of two indices (long and short) for each different row in FIG. 1 and then decide which row, and whether short or long in that row, yields the most gain. The rows can be chosen by any method such as choosing a row where at least one of the indices is greater than some predetermined amount of guaranteed profit. The present invention thus not only includes a method to make a guaranteed gain with no risk, but also a method of computing which of several tactics to use to accomplish that. However, there is no reason why the market maker needs to user a put and call from the same row. It is within the scope of the present invention to choose the put and call from different rows with the same or different strike price and/or term.

It can also be appreciated that a computer program could be written to automatically scan market data and then apply the principles of the present invention to identify profitable opportunities and even execute them.

As has been previously stated, the present invention does not require the use of stock and stock options, or even equities, but rather anything of value that can be protected from both a rise or fall in the market for that item by buying and selling a short term protection devices with a premium received for selling and a premium paid for buying and where there is a spread between the selling and buying prices for buying an upward protection and selling a downward protection or for buying a downward protection and selling an upward protection. In particular the underlying equity can be a futures contract and the protection devices can be futures options.

The invention has been explained through the use of examples and illustrations. Many other changes and variations are within the scope of the invention. The scope of the invention is determined by the claims not by the description.

I claim

1. An investing method for a market maker to realize a guaranteed short term gain comprising:
buying an instrument at or near a market price;
selling a first short term protection device covering a market increase at or near an ask price, said short term protection having a first strike price and first term;
buying a second short term protection device covering a market decrease at or near a bid price, said short term protection having a second strike price and a second term;
exercising the said second short term protection device for market decrease if the market has decreased by the end of said first or second term, said market maker receiving a guaranteed gain of ask price minus bid price minus market price plus said first or second strike price;

2. The method of claim 1 wherein said instrument is a stock.

3. The method of claim 1 wherein said first and second short term protection devices are stock options.

4. The method of claim 3 wherein said first short term protection device is a call.

5. The method of claim 3 wherein said second short term protection device is a put.

6. The method of claim 1 where said first and second strike prices are the same.

7. The method of claim 1 wherein said first and second terms are the same.

8. The method of claim 1 wherein said instrument is a futures contract.

9. The method of claim 8 wherein said first short term protection is a futures option.

10. The method of claim 8 wherein said second short term protection is a futures option.

11. A method for a market maker to realize a guaranteed short term gain comprising:
selling an instrument short at or near a market price;
selling a first short term protection device for market decline at or near an ask price, said first short term protection having a first strike price and first term;
buying a second short term protection device for market increase at or near a bid price, said second short term protection having a second strike price and second term;
exercising the said second short term protection device for a market increase if the market has increased by the end of said short term, said market maker receiving a guaranteed gain of ask price minus bid price minus market price plus first or second strike price;

12. The method of claim 11 wherein said instrument is a stock.

13. The method of claim 12 wherein said first and second short term protection devices are stock options.

14. The method of claim 12 wherein said first short term protection device is a call.

15. The method of claim 12 wherein said second short term protection device is a put.

16. The method of claim 11 where said first and second strike prices are the same.

17. The method of claim 11 wherein said first and second terms are the same.

18. The method of claim 11 wherein said instrument is a futures contract.

19. The method of claim 18 wherein said first short term protection is a futures option.

20. The method of claim 18 wherein said second short term protection is a futures option.

21. A method for investing comprising the steps of:
buying a stock long at or near a market price;
selling a call on said stock at or near an ask price, said call having a strike price and a term;
buying a put on said stock at or near a bid price, said put having said strike price and said term;
exercising said put if the market declines over said term, said market maker receiving a guaranteed gain of ask price minus bid price minus market price plus strike price.

22. A method for investing comprising the steps of:
selling a stock short at or near a market price;
buying a call on said stock at or near an bid price, said call having a strike price and a term;
selling a put on said stock at or near a ask price, said put having said strike price and said term;
exercising said call if the market increases over said term, said market maker receiving a guaranteed gain of ask minus bid plus market minus strike.

23. A method for market investing comprising the steps of:
choosing a row in a stock option quote table by a pair of indices for each row in said table by performing the steps of:
computing a first index according to: put ask price minus call bid price plus strike price minus market price;
computing a second index according to: call ask price minus put bid price minus strike price plus market price;
choosing a row with either a first index or a second index larger than a predetermined amount;
if said first index of said row is greater than said second index, performing the steps of:
buying said stock long at a market price;
buying a put option at said put bid price;
selling a call option at said call ask price;
exercising said put if the market declines during a term of said options, there being a guaranteed profit equal to said first index;
if said second index of said row is greater than said first index, performing the steps of:
selling said stock short at a market price;
buying a call option at said call bid price;
selling a put option at said put ask price;
exercising said call if the market increases during a term of said options, there being a guaranteed profit equal to said second index.
